(19) United States
(12) Patent Application Publication
(10) Pub. No.: US 2009/0125598 A1
(43) Pub. Date: May 14, 2009

(54) METHOD, CLIENT AND SERVER FOR IMPLEMENTING QUESTION AND ANSWER SERVICES

(75) Inventors: Qian Sun, Shenzhen (CN); Yang Zhao, Shenzhen (CN)

Correspondence Address: Leydig, Voit & Mayer, Ltd;(for Huawei Technologies Co., Ltd), Two Prudential Plaza Suite 4900, 180 North Stetson Avenue, Chicago, IL, 60601, US

(73) Assignee: Huawei Technologies Co., Ltd., Shenzhen (CN)

(21) Appl. No.: 12/266,247

(22) Filed: Nov. 6, 2008

(30) Foreign Application Priority Data
Nov. 8, 2007 (CN) 200710124442.7
May 16, 2008 (CN) PCT/CN2008/070999

(51) Int. Cl. G06F 15/16

(52) U.S. Cl. 709/206

(57) ABSTRACT

The invention discloses a method, client and server for implementing the question and answer services. The method includes: by a first client, putting a question into presence information for publishing so that a second client obtains the presence information that contains the question; receiving an answer to the question sent by the second client through an instant message; and displaying the received answer together with the corresponding question. The invention fully utilizes the interpersonal network information in an instant messaging system, and implements the question and answer services based on the presence service and the instant messaging service in the instant messaging system. Therefore, users can ask questions and obtain answers conveniently based on the widely applied instant messaging system.

### CROSS-REFERENCE TO RELATED APPLICATIONS

This application claims priority to Chinese Patent Application No. 200710124442.7, filed Nov. 8, 2007, entitled “Method, Client and Server for Implementing Question and Answer Services,” and to International Patent Application No. PCT/CN2008/070999, filed May 16, 2008, both of which are hereby incorporated by reference in their entirety.

### FIELD OF THE INVENTION

The invention relates to the instant messaging field, and in particular, to a method, client and server for implementing question and answer services based on the instant messaging and presence services.

### BACKGROUND OF THE INVENTION

The online question and answer services are applied widely in the world. Large question and answer websites include http://zhidao.baidu.com/, http://www.sowang.com/sinacha.htm (IASK of Sina), and http://answers.yahoo.com/. Most of such websites let the users get registered and earn points. After being registered as a member, a user can ask questions or answer the questions of others, and earn points if the answer is excellent. On such question and answer websites, the user can raise questions to seek answers from other users, and can see the questions and answers of others. The question and answer services are a supplement to the search engine. For some questions, the user can hardly obtain answers through a search engine, and manual answering will never be totally replaced by machine answering.

On some question and answer websites, however, the users are usually strangers to one another, and they provide answers primarily for the purpose of earning points and using the accumulated points to obtain quicker answers to their questions. In fact, friends are more willing to help each other, and some questions are more suitable for being answered by familiar people such as colleagues and schoolmates. Instant messaging is now more and more popular among people. Instant messaging tools provide not only instant messages, but also the functions of managing contacts and displaying the presence information of contacts, and have become the most ideal means of building a modern interpersonal network. If implemented, the question and answer services based on an instant messaging tool will be a significant improvement and supplement to the current question and answer service primarily provided on question and answer websites.

A common instant messaging tool includes three parts: instant messaging, presence information, and contact management. Many instant messaging tools implement interworking between the instant messaging service and the short/multimedia message service, and support multimedia communications in the form of voice and video, or even interworking with the traditional telephone service. The interpersonal network built through contact management in the instant messaging tools is the most valuable and worthy of exploration.

### SUMMARY OF THE INVENTION

An embodiment of the invention provides a method for implementing the question and answer services to help a user raise questions and seek answers through popular instant messaging tools.

An embodiment of the invention provides an instant messaging client through which a user can ask questions and seek answers.

An embodiment of the invention provides an instant messaging server which provides the question and answer services based on the instant messaging and presence services.

An embodiment of the invention provides another method for implementing the question and answer services to help a user raise questions and seek answers through popular instant messaging tools.

The embodiments of the invention provide the following technical scheme.

A method for implementing the question and answer services includes: by a first client, putting a question into presence information for publishing so that a second client obtains the presence information that carries the question; receiving an answer to the question sent by the second client through an instant message; and displaying the received answer together with the question.

An instant messaging client includes: a question and presence information setting module, adapted to receive input of a question, and put the question into the presence information for publishing; an answer and instant message sending module, adapted to retrieve the question from the presence information, receive the input of an answer, and send the answer through an instant message; a question and answer displaying module, adapted to display the answer in the instant message together with the question.

An instant messaging server includes: a presence information processing module, adapted to receive presence information that carries a question, and distribute the question; and an instant message processing module, adapted to receive and forward an instant message that carries an answer to the question.

A method for implementing the question and answer services includes: receiving and distributing presence information that carries a question; and receiving and forwarding an instant message that carries an answer to the question.

### BRIEF DESCRIPTION OF THE DRAWINGS

FIG. 1 shows a flowchart of the method for implementing the question and answer services in an embodiment of the invention;

FIG. 2 shows the structure of the instant messaging client in an embodiment of the invention; and

FIG. 3 shows the structure of the instant messaging server in an embodiment of the invention.

### DETAILED DESCRIPTION OF THE INVENTION

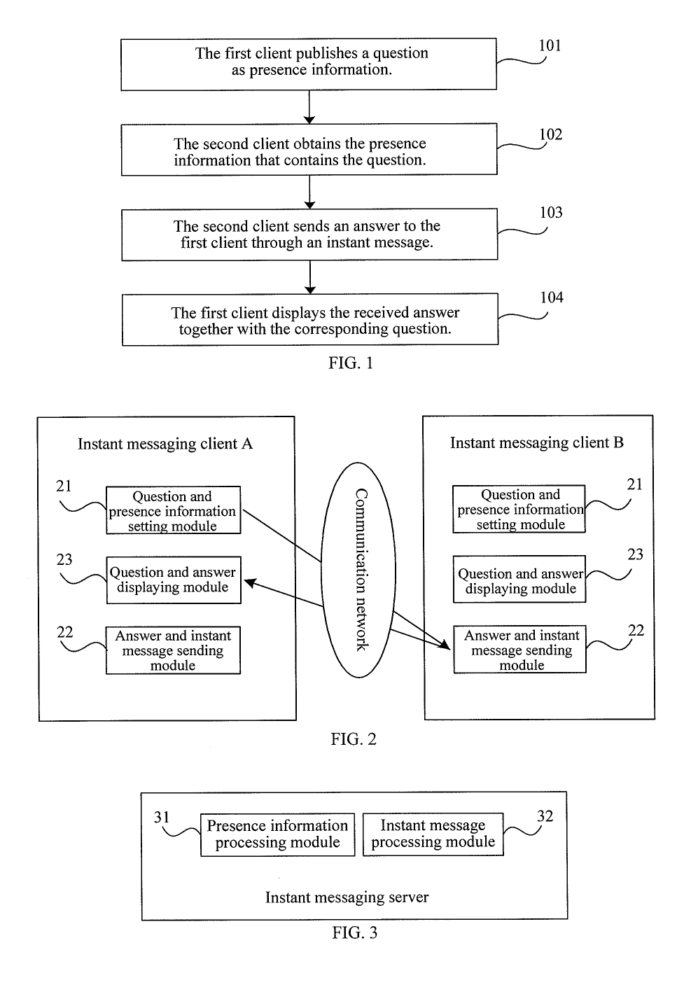

As shown in FIG. 1, the basic process of implementing the question and answer services in an embodiment of the invention includes the following steps:

Step 101: A first client publishes a question as presence information. The first client corresponds to the questioner. The presence information that carries a question may be sent to other clients that have subscribed to the presence information, or be published to a presence server which will distribute the presence information. For ease of implementation, only one question is carried in the presence information.

Step 102: A second client obtains the presence information that carries the question. The second client has subscribed to the presence information of the questioner, namely, the first client. The second client is generally the client of a user in the contact list of the first client. If the user does not want to receive questions, the user may filter out questions when subscribing to presence information.

Step 103: The second client sends an answer to the first client through an instant message. The second client puts the answer input by the user into the message body of an instant message whose content type is answer, and sends the instant message to the first client.

Step 104: The first client displays the received answer together with the question. Upon receiving the instant message, the first client detects that its content type is answer, and displays the answer in the instant message together with the question to the questioner.

It should be noted that even if only one question is carried in the presence information, a locally unique question identifier should be set for the question, and the instant message that carries the answer sent by the second client should also carry the corresponding question identifier. In this way, the first client can match the question with the answer correctly. Otherwise, a match error may occur because the current question is not the question visible to the second client when the first client receives the answer from the second client. Alternatively, when the second client sends the instant message that carries the answer, the question may be directly retrieved from the presence information, and the second client sends the instant message that carries the answer and the corresponding question to the first client.

In the first embodiment, the question and answer services are implemented through the instant messaging and presence service specifications based on the Session Initiation Protocol (SIP) of the Internet Engineering Task Force (IETF). The client that publishes the question presence information may be called a “presentity”, and the client that subscribes to the question presence information may be called a “watcher”. In practice, the client may publish its presence information and subscribe to the presence information of others. The client referred to here has the client functions of the presence service and the instant messaging service.

First, the current presence information is extended, and a question is added. For example, a question is added in the current <person> element. An example of the content is given below:

```
      <person>
    <question-list>
          <question id=“q1s34r”> Who can buy a train ticket
dated October 1? </question>
          <question id=“q2f27h”>What is the telephone number
          of Jane? </question>
    </question-list>
    </person>
```

The <person> element contains a <question-list> subelement. This <question-list> subelement includes one or more question elements such as <question>. Each question element has an identifier attribute such as “id”, which uniquely identifies a question. The value of a question element may include the specific text information of a question.

Besides, a validity period may be set for each question. The value of the validity period may be an absolute time such as “2007-11-06T12:10:00 Z”, which represents the end time of validity of the question. The question turns invalid upon expiry of the validity period. The server may automatically clear the invalid questions in presence information, and the watcher may stop displaying invalid question presence information.

Sometimes the questioner is eager to know the answer. An urgency mark may be set in the question presence information. The watcher may highlight the question presence information that carries an urgency mark, for example, display red or a flashing question mark beside the icon of the questioner, or display an SOS icon that indicates urgency. The following example describes question presence information that contains a validity period and an urgency mark:

<question id=“q2f27h” until=“2007-11-06T12:10:00Z” urgent=“true”>

What is the telephone number of Jane?</question>

The validity attribute “until” of the question element contains the end time of validity of the question, and the urgency attribute “urgent” is set to “true”, which means the question is urgent.

The presentity puts the question into a presence information event packet for publishing. Specifically, the SIP PUBLISH method may apply. An example of the content of a PUBLISH message is given below:

```
    PUBLISH sip:usera@example.com SIP/2.0
    Event: presence
        Content-Type: application/pidf+xml
          <person>
        <question-list>
            <question  id=“q3t82z”>Is  there  any  tea
shop  nearby  Baicao  Garden?</question>
        </question-list>
        </person>
```

For ease of description, part of the message header and the message body of PUBLISH is omitted. The header field “Event” contains “presence” which indicates that the published content is presence information. The Content-Type of the presence information is “application/pidf+xml”. Generally, presence information includes service and device information, namely, one or more <tuple> and <device> elements. For details, see the specifications of the IETF SIMPLE working group such as RFC 4779 (A Data Model for Presence).

The presence server sends presence information that carries the question to the watcher through the SIP NOTIFY method. The watcher displays the received question. Specifically, a question mark can be displayed beside the corresponding user in the contact list window. When the mouse pointer rests on the question mark, the question of the user is displayed through a floating window. When intending to answer the question, the watcher may click the question mark. The watcher obtains the question identifier in the presence information, and displays a window for inputting the answer. Then the watcher sends the input answer together with the corresponding question identifier to the questioner through a SIP message. The content of the message is partly exemplified below:

MESSAGE sip:usera@example.com SIP/2.0
Content-Type: application/answer+xml
<answer question-id=“q2f27h”>
The telephone number of Jane is 28787351.
</answer>

Some of the contents are omitted. The message contains a message body whose content type is answer, for example, “application/answer+xml”. The content of the message body may contain an answer element such as <answer>. The answer element may contain a question identifier attribute such as “question-id”, and the value of the answer element contains the relevant text information.

The client that receives the message detects that the content type of the instant message is answer, and obtains the corresponding question in the presence information according to the question identifier in the message body. Then the client displays the question in the presence information together with the corresponding answer in the message body.

The client may record the question and corresponding answer(s) according to the relation between the question and the answer. One question may correspond to multiple answers. Such question and answer records may be queried by the user in the future, or forwarded to other users.

For some questions, the user may want to be notified when an answer is available, but the user is unable to obtain instant messages when offline. The user may set whether to receive notifications in real time for a specific question. Specifically, the user may set a question identifier and the corresponding mobile phone number on the instant messaging server. Upon receiving an instant message when the user is offline, where the question identifier is the same as the setting of the user, the instant messaging server forwards the text (namely, the answer) in the message to the mobile phone number set by the user through a protocol such as Short Message Point-to-Point (SMPP) via the short message service center (SMSC), or through an MM7 interface protocol via the multimedia message service center (MMSC).

To fully utilize a question and answer website, the presence server may submit the question to the question and answer website automatically after the question presence information is published to the presence server. To avoid duplicate questions, forwarded questions may be forbidden from being published to the question and answer website. The answer to the question on the website may be automatically carried in an instant message, which will be sent to the questioner. Moreover, the presence server may submit the question to the Blog website of the user. In this way, the Blog page of the user may display a tab such as “My question”, which contains all questions asked by the user.

If interested in an existing question on the question and answer website after logging in to the website, the user may click a button on the question and answer page to put the question into the presence information of the user. Specifically, after receiving a HyperText Transfer Protocol (HTTP) setting request of the user, the question and answer website (which serves as a presence information source of the user) publishes the question as presence information to the home presence server of the user. The presence server combines the question with other presence information published by the user, and distributes the combination to the subscriber. Generally, the user has registered an address identifier on the question and answer website, and an email address is generally used as an account identifier for logging in to the question and answer website, and the instant messaging and presence server.

A community friend-finder website may essentially provide a contact list, namely, an interpersonal network, which is available from an instant messaging tool, for example, Facebook, Myspace, Campus website and Chinese community. Such websites may also provide the question and answer service application. A question may be set in the “Personal Information” on the website, and the user may see the question while browsing personal information of other users on the website. Then the user may provide an answer to the question on the website. The user who asks the question may query the status of the question and the corresponding answer. The question and answer services based on an interpersonal network abandon the complex points earning system for motivating the user to answer questions, but fully utilize the existing interpersonal data in a communication network.

The technical scheme of the invention may be used together with some incentive mechanisms, for example, points rewarding and points earning. If the question and answer service system supports virtual money or virtual goods, the virtual money or virtual goods may substitute for the points earned. For example, after obtaining an answer, the questioner may give the replier a certain amount of virtual money or virtual goods as a reward.

The second embodiment of the invention provides a method for wider spreading of questions. The presence information of a user is usually visible only to the user's contacts. A common user generally has only up to two hundred contacts, among which, fewer, one hundred on average, are online simultaneously with the user. In fact, if more people know the question, the possibility for the user to obtain the answer will be higher. Therefore, it is best to let more people see the question. In this embodiment, when the client of user A publishes question presence information, the client of user B who subscribes to the presence information of user A receives the question presence information, and may publish the question presence information as his own presence information. The question presence information published by the client of user B carries the question questioner and the original question identifier in addition to the question. Example:

```
      <person>
    <question-list>
        <question id=“p14ts9”>
    <description>Is there any tea shop nearby Baicao
    Garden?</description>
    <original-questioner qid=“q3t82z”>sip:usera@example.com
    </original-questioner>
    </question>
    <question id=“p25sd3”>
    <description>Which  market  in  Nanshan  district  sells
fresher  vegetables  and pork?</description>
      </question>
    </question-list>
      </person>
```

The question list of user B contains two question elements: (1) Question of user A. The <description> subelement contains the description about the question, and the <original-questioner> subelement contains the identifier of the original questioner such as “sip:usera@example.com” and the original question identifier such as “qid”. The user identifier is generally a SIP uniform resource identifier (URI), and may also include a display name or a nickname, for example, “Alice <sip:usera@example.com>”. (2) Question of user B, which contains only a <description> subelement. The question identifier attribute values of the two question elements are generated by the client of user B, and each question identifier is valid if it is unique in the question set of user B. It does not matter if the question identifier is the same as the original question identifier of another user such as user A.

The client may publish the question of a contact automatically as its own question through default settings. The client may set an upper limit of questions, for example, 10 questions, to avoid too many questions. When the total number of questions reaches the upper limit and the user wants to publish the questions, the user may replace the existing questions of a contact with his own questions. The user may further set whether to publish the questions forwarded by a contact automatically as his own questions. In the foregoing example, the question that contains the <original-questioner> information is not asked by user B, and the client of user C as a contact of user B can set whether to forward such question as forwarded by user B. If user C forwards the question, the original questioner identifier corresponding to the question published by the client of user C is still the identifier of user A, for example, “sip:usera@example.com” rather than the identifier of user B. In this way, even after the question is forwarded for many times, the client that finally provides the answer can still send the answer to the original questioner directly according to the answer message. Moreover, the information in <original-questioner> can avoid repeated cyclic forwarding of a question. The relationship network between users is overlapped. If a client recognizes that the question has been published by it according to the original questioner identifier and the question identifier in the question to be forwarded, the client does not forward it again. Through the method in an embodiment of the invention, a question can be forwarded in the interpersonal network of a user widely.

If a user deletes a question in the presence information published by the user, the presence server also removes the question in the update notification that carries the presence information sent to a contact, namely, a subscriber to the presence information of the user. Afterward, if the client of the contact forwards this question, the forwarding will be cancelled.

The original questioner may want to know the interpersonal path of the persons who provide an answer in addition to the answer. The client may publish the path of forwarding a question as presence information, put the identifiers of the forwarding users into the <via> element sequentially, and put the corresponding question identifier into the question identifier attribute of the element, for example, “qid”. In the foregoing example, if contact C of user B wants to forward the question, the question presence information may be as follows:

```
<question id=“p41r1t”>
  <description>Is there any tea shop nearby Baicao
  Garden?</description>
  <via qid=“q3t82z”>sip:usera@example.com</via>
  <via qid=“p14ts9”>sip:userb@example.com</via>
</question>
```

The <via> elements are arranged from the top down, and the topmost path node element <via> includes the identifier of the original questioner. When a client forwards a question, the client puts the identifier of the previous user who publishes the question into the <via> element of the question. To prevent excessive forwarding of the question, an upper limit of forwarding may be set. Specifically, the upper limit is set according to the quantity of <via> elements. For example, when the client or server finds that the quantity of <via> elements in the question reaches the upper limit, for example, “3”, the question will not be forwarded any more.

If contact D of user C wants to provide an answer, the client of contact D puts the answer into a SIP message request, which may also include the propagation path information of the question retrieved from the presence information. This message may be sent only to user A who originally asks the question, or to all users that forward the question. Example:

```
  MESSAGE sip:usera@example.com SIP/2.0
  From: sip:userd@example.com
  Content-Type: application/answer+xml
  <answer>
    <description>Mingxuan  tea  shop  in  Baicao  Garden,
TEL 28780808</description>
    <via qid=“q3t82z”>sip:usera@example.com</via>
    <via qid=“p14ts9”>sip:userb@example.com</via>
    <via qid=“p41r1t”>sip:userc@example.com</via>
  </answer>
```

After receiving the message, the client of user A (B or C) displays the question and the answer in the <description> element in the answer message according to the question identifier corresponding to the user identifier in the <via> element, and may also display the interpersonal path through which user D obtains the question. For example, the client of user A may display the following path:

sip:usera@example.com-> sip:userb@example.com->
sip:userc@example.com-> sip:userd@example.com

The user identifier “sip:userd@example.com” of the last hop in the path is obtained from the “From” header field of the message request.

In the third embodiment, the question asked by a user may be complex, for example, asking about a picture or video, or about comments on an essay. Obviously, pictures, videos and large files are not suitable for being carried in presence information. This embodiment publishes the complex question by putting only the title and the uniform resource locator (URL) of the relevant content into the presence information. Specifically, when the client of the user publishes question presence information, the user inputs the question title and the relevant content (for example, picture, and video). The relevant content is uploaded by the client to the server. The server stores the relevant content and returns a URL to the client, and the client publishes the question title and the URL as question presence information. Example of content:

<question id=“123456”>
<title>Where is this photo taken?</title>
<url>http://www.example.com/usera/qwe213yui456.htm</url>

</question>

The <title> element includes the title of the question, and the <url> element includes the URL of the content. The watcher may access the complete content through the URL in the question. Moreover, in the process of forwarding the question, the URL is also copied and forwarded.

Besides, the answer may be complex rather than a simple text. In this case, the processing is similar. That is, the client uploads the answer to the server, and the server returns a URL of the answer content. The client sends the URL to the user who asks the question.

In the foregoing embodiments, the rights to access the question presence information are not necessarily restricted because the user only wants to know the answer. The question presence information of the user is provided for all users, even including those who are not contacts of the user or are in the hidden state. Moreover, the instant message that answers the question is not blocked in any circumstance. When an instant messaging server detects that an instant message contains a message body of the answer type, if the instant message comes from a stranger, even if the user sets blocking of instant messages from strangers, the server may not necessarily block this instant message.

When a stranger searches for users, the stranger may see the question of the user, and get acquainted with the user by answering the question. In the case of adding an instant messaging contact, authentication is generally required. User A may set a question. When user B requests to add user A as a contact, the client of user B displays the question of user A and prompts user B to input the answer. The question and the answer are carried in the request for adding a contact and sent to the client of user A. When displaying the request, the client of user A may display the question and the answer at the same time. User A may decide whether to approve the request according to the answer.

Some questions may be more suitable for being published in a specified group or among some specific users. For example, “who knows the mobile phone number of my colleague Martin” is only suitable for being published in the colleague group. Specifically, after the client selects a group or some contacts, and then publishes the question, the rights of subscribing to the question presence information are limited to the selected group or contacts. The following is an example of the content of the corresponding presence authorization rules:

```
<ruleset><rule id=“a”>
    <conditions>
      <identity><many domain=“huawei.com”></identity>
    </conditions>
    <actions><sub-handling>allow</sub-handling></actions>
    <transformations>
      <provide-question-list>
        <question-id>q3t82z</question-id>
</provide-question-list >
    </transformations>
</rule></ruleset>
```

The rule set includes a rule. The “conditions” element specifies the home domain of an authorized user, for example, “huawei.com”, and the “actions” element specifies the authorization action as “allow”. The “transformations” element specifies the identifier of the question that is allowed to be provided, for example, “q3t82z”. The presence authorization rules may be set by the client that publishes the question presence information through the Extensible Markup Language Configuration Access Protocol (XCAP). When a watcher subscribes to the presence information of the user, the presence server checks whether the watcher meets the conditions according to the authorization rules, namely, whether the home domain is “huawei.com”. If so, the server sends the corresponding question to the watcher through a notification message. Otherwise, the server does not provide the question.

If any other user such as a contact is also interested in the answer, the client of the user may send an instant message to the original questioner, showing the intention to know the question and the answer (if any). This instant message indicative of concern about the question is partly exemplified below:

MESSAGE sip:usera@example.com SIP/2.0
Content-Type: application/focus-question+xml
<focus qid=“q3t82z”/>

This message body includes a <focus> element, and its attribute value is the identifier of the question that the user is concerned about. After the original questioner approves, a question concern record is generated at the client of the original questioner. When the original questioner obtains an answer, the answer is sent to other users who are concerned about the question through a message.

After receiving the answer, the client may publish the answer as presence information. The following is an example of presence information that contains the question and the answer:

```
<question id=“p9tr3r2”>
  <description>Which bus travels from Longgang to Shekou?
  </description>
  <answer id=“1” by=“sip:userc@example.com”>Bus 338</answer>
</question>
```

There may be one or more <answer> elements. Each answer element has an identifier attribute such as “id”. This identifier is unique within the parent element <question>. The replier attribute <by > contains the identifier of the user who provides the answer.

In the fourth embodiment, if the answer is long or the replier expects to provide the answer through several interactions, the Message Session Relay Protocol (MSRP) may be applied. For details of the protocol, see the IETF standard RFC4975. The instant message based on SIP is also known as instant message of “paging mode”, which is similar to a short message. The instant message based on MSRP is also known as instant message of “session mode”. Specifically, the client intending to provide an answer requests the questioner to set up an MSRP session by sending a SIP INVITE request. The question identifier is contained in the attribute corresponding to the MSRP medium in the Session Description Protocol (SDP) message body of the INVITE request. The content of the INVITE request is partly exemplified below:

INVITE sip:usera@example.com

m=message 7777 TCP/MSRP*

a=accept-types:text/plain

a=path:msrp://userbpc.example.com:7777/iau39soe2843z;tcp

a=question:p9tr3r2

The value of the “question” attribute is the question identifier such as “p9tr3r2”.

After receiving the SIP INVITE request, the client of the original questioner retrieves the question identifier from the SDP message body, and displays the question in the presence information corresponding to the question identifier to the user. If the user agrees to communicate, the client returns a 200 OK response to the sender of the INVITE request. After an MSRP session is set up, the client that provides the answer may send a message content text through a SEND command based on MSRP. Large files can be sent in multiple attempts through the block-by-block transfer mechanism. Moreover, both parties may interact through the established MSRP session. All interactive message records are correlated to the corresponding question identifiers. That is, an interactive message record may be used as an answer to the question.

If there is an ongoing MSRP session correlated to a question when another party originates an INVITE request to the questioner for setting up an MSRP session about the same question, that is, the question identifier in the “question” element in the SDP message body is the same, the client of the questioner may add the new party to the existing MSRP session, and use the path and port parameters of the existing MSRP session for the SDP message body in the “200 OK” response message.

Moreover, the question in the SDP media attribute may also contain the question, for example,

a=question:p9tr3r2; who can lend me ten thousand dollars?

If the replier expects to provide an answer in the voice or video mode, for example, an answer to “who can demonstrate ballroom dancing?”, the client of the replier originates a multimedia session request, for example, an RTP voice and video session request through SIP INVITE. Similar to the settings in the foregoing MSRP session, a question indicator is set in the media attribute “a” of SDP. By identifying this question indicator, the client that receives the request can record the multimedia session related to this question automatically. The multimedia session may also be regarded as an instant message of a session mode.

The fifth embodiment of the invention publishes question presence information through XCAP. The presence information published through SIP is generally limited by a validity period. The client must be refreshed continuously. If the client is offline, the presence information published through SIP will be invalid, and the presence server will clear the invalid presence information. Nevertheless, the question may be provided for other users while the user is offline. In this way, the probability of obtaining the answer is increased because other users may not necessarily be online while the questioner is online. In this embodiment, the relatively static question presence information is published through the XCAP protocol. The content of the publish command “HTTP PUT” is exemplified below:

PUT /pidf-manipulation/users/sip:someone@example.com/index/
~~/presence/person%5b@id=‘x8eg92n’%5d/question HTTP/1.1
If-Match: “xyz”
Host: xcap.example.com
Content-Type: application/xcap-el+xml
...

<question> Is the house price falling in Shenzhen?</question>

This embodiment assumes that the presence information <person> contains one <question> element, and this element contains the question description text. The XCAP address in the request line of the PUT command contains the node path of the question element of the user's presence information. This PUT message body contains the specific contents of the <question> element. The question presence information published through XCAP PUT does not impose the restriction of a validity period. The presence server regards the question presence information as valid when the client of the user is not refreshed or is even offline.

The sixth embodiment of the invention implements the question and answer services based on the Extensible Messaging and Presence Protocol (XMPP). First, the user publishes a question. The content of the publish message in the XML format is partly exemplified below:

```
<iq type=‘set’
    from=‘usera@example.com/ca486eba-0f9a-11dc-8835-
    000bcd821bfb’
    id=‘publish1’>
  <pubsub xmlns=‘http://jabber.org/protocol/pubsub’>
    <publish node=‘http://jabber.org/protocol/question’>
      <item>
        <question xmlns=‘http://jabber.org/protocol/question’
xml:lang=‘en’>
          Where is Tom?
        </question>
      </item>
    </publish>
  </pubsub>
</iq>
```

The node attribute of the <publish> element indicates that the question node is published. The <question> subelement in the <item> element contains a specific question. Moreover, this question element may also contain a language attribute that indicates the language type such as English or Chinese. The <item> element may contain multiple <question> subelements. The language attribute must differ between <question> subelements. That is, all <question> subelements in an <item> element should be instances of the same question in different languages. In this way, one user has at most one question at a time, and can simply match the question with a returned answer. If no question exists in the current presence information when an answer is received, the answer matches the question in the last published presence information.

Afterward, the question is sent to all subscribers through an XMPP <message>. The message content is exemplified below:

```
<message
    from=‘usera@example.com’
    to=‘userb@example.com’>
  <event xmlns=‘http://jabber.org/protocol/pubsub#event’>
    <items node=‘http://jabber.org/protocol/question’>
      <item id=‘b5ac48d0-0f9c-11dc-8754-001143d5d5db’>
        <question xmlns=‘http://jabber.org/protocol/question’
            xml:lang=‘en’>
          Where is Tom?
        </question>
      </item>
    </items>
  </event>
</message>
```

When another client returns an answer, the answer can also be sent through an XMPP <message>. Example:

```
<message to=‘usera@example.com’
      from=‘userb@example.com’
      xml:lang=‘en’>
  <body>Answer: Where is Tom?</body>
  <answer xmlns=‘http://jabber.org/protocol/answer’>
    Tom is in the gym.
  </answer>
</message>
```

To avoid mismatch between the answer and the current question, the answering client may put the corresponding question into the <body> element, and preferably add a prefix such as “Answer:” before the question description to indicate that the message is an answer to the question. The <answer> element contains the answer text. In this way, even if the answer mismatches the current question of the user, the user can still see the corresponding question in the content in the <body> element.

It is understandable to those skilled in the art that all or part of steps of the preceding embodiments may be implemented by hardware following instructions of programs. The programs may be stored in a computer-readable storage medium. When the programs are executed, the process includes the following steps if the programs are located on the client of the user who asks a question: putting the question into presence information for publishing; and displaying the received answer together with the corresponding question.

[The process includes the following steps when the programs are located on the client of the user who provides an answer: obtaining the presence information that contains a question; and sending an answer through an instant message.

The storage medium mentioned above may be a read-only memory (ROM), a disk or a CD.

As shown in FIG. 2, the instant messaging client that provides the question and answer services may include: a question and presence information setting module 21, adapted to receive the input of a question and put the question into the presence information for publishing; an answer and instant message sending module 22, adapted to retrieve the question from the presence information, and receive the input of an answer and send the answer through an instant message; and a question and answer displaying module 23, adapted to display the answer in the instant message and the corresponding question. To describe the relation between modules clearly, FIG. 2 includes two instant messaging clients A and B, which have the same structure. The two clients are interconnected through a communication network for communication. The network elements such as a presence server are located in the communication network. The presence information published by the question and presence information setting module on the instant messaging client A is sent to the instant messaging client B through the communication network. The answer and instant message sending module on client B retrieves the question from the presence information. The question and answer displaying module on the instant messaging client A receives the answer from the answer and instant message sending module on client B.

The instant messaging client may also include a question presence information forwarding module, adapted to put the retrieved question into its own presence information for publishing. It may also include a static question presence information setting module, adapted to receive the input of a question, and publish the question to a server through XCAP. It may also include a question and answer session module, adapted to set up and perform sessions related to questions. In the event that an MSRP or RTP session is originated through SIP INVITE, the process has been described in detail in the foregoing embodiments, and not described further. The instant messaging clients of both parties perform question-related sessions through the question and answer session module. This module can also record the session process. The session records serve as an answer to the relevant question.

As shown in FIG. 3, the instant messaging server in an embodiment of the invention includes: a presence information processing module 31, adapted to receive the presence information that carries a question, and distribute the question; an instant message processing module 32, adapted to receive an instant message that carries an answer to the question, and forward the instant message. The two modules may be physically located on different servers, for example, one is on a presence server, and the other is on an instant message server, to improve the processing capability.

In one embodiment, one or more computer readable media comprises computer program codes for implementing question and answer services to helping a user raise questions and seek answers through popular instant messaging tools. The computer program codes may be logic encoded in one or more tangible media for execution. As used herein, logic encoded in one or more tangible media is defined as instructions that are executable by a programmed processor and that are provided on computer-readable storage media, memories, or a combination thereof. When executed, the logic is operable to put by a first client, a question into presence information for publishing so that a second client obtains the presence information that carries the question; receive, by the first client, an answer to the question sent by the second client through an instant message; and display, by the first client, the answer together with the question. When executed, the logic encoded in one or more tangible media is also operable to receive and distribute presence information that carries a question; and receive and forward an instant message that carries an answer to the question.

Although the technical scheme of the invention has been described through some exemplary embodiments, the invention is not limited to such embodiments. It is apparent that those skilled in the art can make various modifications, variations and substitutions to the invention without departing from the spirit and scope of the invention. The invention is intended to cover the modifications, variations and substitutions provided that they fall in the scope of protection defined by the following claims or their equivalents.

What is claimed is:

1. A method for implementing question and answer services in a computer network environment to helping a user raise questions and seek answers through popular instant messaging tools, comprising:
putting, by a first client in the network environment, a question into presence information for publishing so that a second client in the network environment obtains the presence information that carries the question;
receiving, by the first client, an answer to the question sent by the second client through an instant message; and
displaying to the user at the first client the answer together with the question.

2. The method of claim 1, wherein, after the first client publishes the presence information carrying a question, a third client obtains the presence information and publishes a presence information of the third client which carrying the question;
the second client obtains the question of the first client through the third client.

3. The method of claim 2, wherein the third client publishes the presence information carrying a user identifier of the first client, a question identifier and the question; and the second client sends the answer and, the question identifier or the question, to the first client according to the user identifier.

4. The method of claim 3, wherein the second client sends a forwarding path of the question to the first client.

5. The method of claim 1, wherein, after the first client publishes the presence information, the question is obtained by the second client after being forwarded at least twice;
the second client sends the answer to the first client or a client of a node of the forwarding path via a instant message, wherein the instant message comprises forwarding path information of the question.

6. The method of claim 5, wherein, one node client of the forwarding path sends an instant message indicative of concern about the question; and
the first client sends the answer to the node client after obtaining the answer.

7. The method of claim 1, wherein, the question published by the first client comprises a question identifier corresponding to the question;
the instant message sent by the second client comprises a question identifier corresponding to the answer; and
the first client matches the question identifier and the corresponding question, and displays the answer and the corresponding question together according to the received instant message.

8. The method of claim 7, wherein the answer is comprised in a message body of which the content type is answer;
when the first client detects that the received instant message comprises the message body of which the content type is answer, obtains the question identifier from the instant message, and obtains the corresponding question according to the question identifier.

9. The method of claim 1, wherein when the second client sends the answer to the first client by the instant message, the second client sends the answer corresponding to the question to the first client together.

10. The method of claim 1, wherein the first client publishes the answer contained in the presence information after receiving the answer.

11. The method of claim 1, wherein when the answer or the question is sent to a server, the server returns an address corresponding to the question or an address corresponding to the answer;
when publishing the question, the first client puts the address corresponding to the question into the presence information for publishing; and
when obtaining the question according to the address corresponding to the question, and the second client puts the address corresponding to the answer into the instant message when sending the answer.

12. The method of claim 1, wherein the first client publishes the question as a static presence information.

13. The method of claim 1, wherein the second client sends the answer to the first client by an instant message in session mode.

14. The method of claim 13, wherein the second client puts the question identifier into attribute of an SDP content of a SIP request, and sends the SIP request to the first client.

15. The method of claim 1, wherein the first client or presence server publishes the question on the question and answer websites or web blogs after the first client puts the question into the presence information for publishing.

16. The method of claim 1, wherein the number of the question published by the first client is not more than one;
when the first client detects that the content type of the received instant message is answer type, the first client displays the answer of the instant message and the question of the presence information published by the first client together.

17. The method of claim 1, wherein the presence information published by the first client comprises period of validity and/or urgent identifier.

18. An instant messaging client in a computer network environment comprising:
a question presence information setting module, configured to receive a putting question, and publish the question contained in the presence information;
an answer instant message sending module, configured to obtain a question, receive a putting answer, and send a answer by an instant message; and
a question and answer displaying module, configured to display the answer in the instant message and the corresponding question.

19. The instant messaging client of claim 18, further comprising a question presence information forwarding module, configured to put the question into the presence information for publishing.

20. The instant messaging client of claim 18, further comprising a static question presence information, configured to receive input of a question, and publish the question to a server by XCAP protocol.

21. The instant messaging client of claim 18, further comprising a question and answer session module, configured to establish and process a session related to the question.

22. An instant messaging server, comprising:
a presence information processing module, configured to receive presence information that carries a question, and distribute the question; and
an instant message processing module, configured to receive and forward an instant message that carries an answer to the question.

23. A method for implementing the question and answer services in a computer network environment to help a user raise questions and seek answers through popular instant messaging tools comprising:
receiving and distributing at nodes of the network presence information that carries a question; and
receiving and forwarding at nodes of the network an instant message that carries an answer to the question.

24. One or more computer readable media, comprising logic encoded in the computer readable media, the logic when executed operable to implement the method according to the claim 1.

25. One or more computer readable media, comprising logic encoded in the computer readable media, the logic when executed operable to implement the method according to the claim 23.
